(19) United States
(12) Patent Application Publication
(10) Pub. No.: US 2026/0061347 A1
(43) Pub. Date: Mar. 5, 2026

(54) Filtration Unit For Processing a Liquid

(71) Applicant: GEA FOOD SOLUTIONS BAKEL B.V., Bakel (NL)

(72) Inventor: Joost Van Erp, Nuenen (NL)

(21) Appl. No.: 19/108,214

(22) PCT Filed: Sep. 4, 2023
(86) PCT No.: PCT/EP2023/074151

§ 371 Date: Mar. 3, 2025

(30) Foreign Application Priority Data
Sep. 5, 2022 (EP) 22193980.4
Oct. 4, 2022 (EP) 22199502.0

(51) Int. Cl. B01D 29/03; B01D 29/90; C02F 1/00; C02F 1/32; C02F 103/32

(52) U.S. Cl. CPC B01D 29/035; B01D 29/902; C02F 1/004; C02F 1/325; C02F 2103/32; C02F 2303/04

(57) ABSTRACT

A filtration unit for processing a liquid, that includes an inlet, an outlet, a filter, and a disinfection means, the inlet and the outlet are each connected to a food processing machine, the disinfection means includes an ultraviolet-radiation source, the disinfection means is configured to irradiate ultraviolet-radiation onto a filtration surface, the filtration surface has a length and a width that is overflown by the liquid during filtration, the length of the filtration surface extends parallel to a liquid flow direction and the width extends perpendicular to the liquid flow direction, the filter has openings and a number of the openings increase with progressing length of the filter.

### CROSS REFERENCE TO RELATED APPLICATIONS

This application is a U.S. National Stage of PCT/EP2023/074151 filed on Sep. 4, 2023, which claims priority to EP 22193980.4 filed Sep. 5, 2022 and EP 22199502.0 filed Oct. 4, 2022, the entireties of which are all incorporated by reference herein for all purposes.

### FIELD

The present invention relates to a filtration unit for processing a liquid, wherein a filtration unit is connected to a food processing machine and comprises a filter and an ultraviolet-radiation source for the disinfection of the liquid. Further the invention relates to a method for processing a liquid.

### BACKGROUND

Such a system is well known from the state of the art, for example U.S. Pat. No. 4,094,237 A, which discloses an apparatus for purifying bacterially-contaminated brine overflow from a bacon curing machine. The contaminated brine is collected in a collecting tank, passed through a filter and mixed with fresh brine which is directed to the back of the filter to back-wash the filter. This brine-mixture is passed through a series of ultra-violet liquid purifying devices and then through a second filter. The system comprises a tank for the collection of used brine overflow, wherein additional fresh brine is added to the tank. The tank comprises a skimmer, which extracts pieces of fat from the surface of the brine and further a filter head is placed within the tank. The mixture of contaminated and fresh brine is drawn through the filter head and pumped through a pipe to the ultra-violet purifying means. The purifying means are pipe shaped and comprise an inlet and an outlet, wherein the ultraviolet-radiation is contained within. Brine flows into the pipe and around an ultraviolet-radiation source. Although the liquid is prefiltered, particles with smaller diameters than the filter opening and fats within brine are drawn into the ultra-violet purifying means. With increasing time of usage, the ultraviolet-radiation source decreases in efficiency due to build-up of a dirt film around the source. The film comprises fats and particles. The pipelike construction makes the cleaning of the purifying means more difficult and leads to losses of efficiency. This is an especial downside in the food industry as the standards for clean machinery and uncontaminated fluids used are extremely high.

Other systems are known from EP 1 737 795 B1 and DE 10 2011 112 994 A1, which also disclose pipelike devices for the treatment of a fluid medium via UV-radiation face the same difficulties as listed above. The contaminated fluids either flow around an ultraviolet-radiation source or through a plurality of sources creating non-reachable areas for cleaning. This in addition to the complex de-assembly of these apparatuses lead to more time-consuming cleaning and increases the cleaning frequency.

It is therefore an objective of the present invention to avoid the problems according to the state of the art and/or to improve known systems.

### SUMMARY

This problem is solved with a filtration unit for processing a liquid, wherein the filtration unit comprises an inlet, an outlet, a filter and a disinfection means, wherein the inlet and the outlet are each connected to a food processing machine, the disinfection means comprises an ultraviolet-radiation source, which is configured to irradiate ultraviolet-radiation onto a filtration surface.

The present invention relates to a filtration unit which is especially designed for the use in combination with a food processing machine, particularly brine injection apparatus. The food processing machine may process typical products such as meat, for example poultry, and/or fish and/or vegetarian food but other products are also feasible. The liquid to be filtered typically comprises solid particles, which are at least partially removed by the filtration unit. Typical particles are for example fat-bone- and/or meat fiber particles. The inlet and outlet of the filtration unit allow a flow of liquid through the filtration unit, whereas the inlet introduces an unfiltered liquid into the filtration unit and the outlet releases the filtered liquid. The filtering is executed by means of a filter, for example a holed board element or a web. This filter comprises a filtration surface and the liquid is preferably passed through the filter. The filter separates the particles from the liquid. The filtration surface typically has a length and a width. In case the filtration surface is overflown by the liquid during filtration, the length of the filtration surface preferably extends parallel to the flow direction. The width of the filter can be seen as extending in a perpendicular direction to the liquid flow direction in a horizontal plane.

According to the present invention, the filtration unit further comprises a disinfection means. This disinfection mean comprises an ultraviolet-radiation source, which radiates UV-electromagnetic waves onto the filtration surface. The emitted radiation is directed onto the filtration surface. The ultraviolet-radiation may be any ultraviolet-radiation source, but in an especially preferred embodiment the ultraviolet-radiation source radiates UV-C-radiation (100 nm-280 nm). UV-A radiation (315 nm-400 nm) and UV-B-radiation (218 nm-315) might also be selected. The usage of UV-C-radiation is advantageous due to its higher amounts of energy, in comparison to UV-A-and UV-B-radiation. UV-radiation with a wavelength below 200 nm can split oxygen molecules and allow for the formation of ozone, which is advantageous for disinfection purposes. A UV-source with a wavelength of 1 nm-100 nm could also be used.

Preferably, UV-radiation is utilized from an artificial UV-radiation source, wherein the artificial UV-radiation source can be any form of mercury-vapor lamps (for example low-pressure, medium-pressure, high-pressure or ultrahigh-pressure) or UV-light emitting diodes (LED) or any other form of UV-radiation emitting light source. Mercury-vapor lamps and UV-LEDs are especially effective for emitting ultraviolet-radiation. It is especially desirable to use UV-LEDs as they are variable in intensity and wavelength and further, UV-LEDs will emit less infrared-radiation than mercury-vapor lamps. Thus, UV-LEDs will cause less undesired warming of the liquid. Using UV-LEDS will also allow for easier checking of the light intensities, higher lifespan and better reliability.

Preferably, the radiation intensity and the distance between the ultraviolet-radiation source and the filtration surface can be varied, for example, depending on the contamination of the liquid and/or the liquid flow rate. Preferably, the frequency and/or the amplitude of the radiation can be varied.

The liquid entering the filtration unit preferably flows onto and/or via the filtration surface and spreads along the length and width of the filtration surface, creating a large surface area for increasing the efficiency of disinfecting the liquid. The liquid is preferably exposed to the UV-radiation, while it is still un-and/or only partially filtered. Hence, both the liquid and the liquid are disinfected.

The system can further comprise a residue basin for the collection of filtered particles.

Preferably, the disinfection means comprises a plurality of ultraviolet-radiation sources. The plurality of ultraviolet-radiation sources can radiate different ultraviolet-radiation intensities and/or different wave-length or the same. The plurality of ultraviolet-radiation sources can be arranged in parallel, for example parallel or perpendicular to the flow of the liquid and/or the length of the filtration surface. Each source can be controlled individually in terms of amplitude and/or wave-length.

According to a preferred embodiment of the present invention, the plurality of ultraviolet-radiation sources are located along the length of the filter. The length of the filter is directed in the in the horizontal plane and defines the extension of the filter in said plane. The length of the filter begins where the liquid flows onto the filter. Preferably, each ultraviolet-radiation source has a longitudinal extension and more preferably, this longitudinal extension is parallel or perpendicular to the flow of the liquid along the filtration surface and/or the lengthwise extension of the filtration surface. The longitudinal extension of the ultraviolet-radiation sources is preferably in parallel to the filtration surface.

The distance of each ultraviolet-radiation source to the filtration surface of the filter may vary between at least two ultraviolet-radiation sources. In regions of high contamination, the ultraviolet-radiation is preferably arranged closer to the filtration surface, wherein in regions of low contamination the ultraviolet-radiation source is preferably arranged higher above the filtration surface.

Alternatively or additionally, the plurality of ultraviolet-radiation sources can be arranged in parallel and parallel to the extension of the width of the filtration surface, wherein the sources can be positioned equidistantly or non-equidistantly over the filtration area. In an even more preferred embodiment, the filtration unit comprises a plurality of ultraviolet-radiation sources, wherein the sources are arranged in a line along the length of the filter, wherein the ultraviolet-radiation sources are preferably parallelly arranged next to each other.

Preferably, each ultraviolet-radiation source is mounted on a movable apparatus, wherein the apparatus can be manually adjustable in height. If there is a plurality of sources extending in a row along the width of the filter, the height can either be adjusted for all the sources in said row simultaneously or for each source individually. Especially preferably, the movable apparatus is actuated by an electric motor, wherein the electric motor is controlled depending on sensor data. Advantageously, the preferred embodiment increases the general efficiency of disinfecting the liquid. Examples of sensors to be used, can be flow rate sensors at the inlet of the filtration unit or testing of liquid quality can be done by suitable sensors to measure contamination of the liquid or temperature sensors may be placed within an existing liquid flow close to the outlet.

According to a preferred embodiment of the present invention, the plurality of ultraviolet-radiation sources are configured to emit different and/or the same intensities and/or different and/or the same wavelengths of ultraviolet-radiation. The variation in intensities and wavelengths between the ultraviolet-radiation sources can advantageously increase the efficiency while also simultaneously decreasing energy consumption. Further, no undesired energy is brought into the liquid, wherein heating up of the liquid can be unwanted.

With progressing length of the filter, the exposure time of the liquid to the ultraviolet-radiation increases. In regions of low contamination, the intensity of ultraviolet-radiation is preferably lowered in order to allow for energy saving.

The intensity of said ultraviolet-radiation sources may also be varied according to sensor data. If the contamination of the liquid or the flow rate increases, a higher intensity of ultraviolet-radiation is preferred. This applies vice versa. Additionally, when the ultraviolet-radiation source is arranged closely to the surface of the filter, the intensity of the source can be reduced. The intensity variation can be dependent on the height of each source, the contamination of the liquid and the flow rate.

Alternatively or additionally, the intensity of the ultraviolet-radiation sources extending in a row along the width of the filter can be varied. If there is a plurality of rows extending along the width (horizontal) of the filter being parallelly arranged along the length of the filter, the intensities in different horizontal rows may be varied. Advantageously allowing for a variation of intensities along the length of the filter, with a plurality of ultraviolet-radiation sources arranged in horizontal rows. Preferably, a UV-LED source is used, wherein the source can be in the form of a fluorescent tube. The fluorescent tube can either extend horizontally or vertically along the length of the filter, wherein the wavelength and/or intensity of the ultraviolet-radiation can be varied along the length of the fluorescent tube. In a preferred embodiment, a plurality of ultraviolet-radiation sources can be used in the form of UV-LED fluorescent tube.

The variation in intensity of the ultraviolet-radiation may follow a linear or a non-linear relationship, especially when an UV-LED fluorescent tube is used. The intensity variation of the ultraviolet-radiation can follow a linear relationship, where the intensity either increases or decreases linearly along the length of the filter with a plurality of ultraviolet-radiation sources. As already stated above, it could be advantageous to have a strong decrease or increase at the end of the filter, which would be dependent on flow rate and contamination of the liquid. This would create a non-linear relationship between the intensity of the sources.

According to a preferred embodiment of the present invention, that at least one further ultraviolet-radiation source is arranged on the opposing side of the filter to the ultraviolet-radiation source. This further ultraviolet-radiation source can be arranged advantageously on the opposing side of the filter to the ultraviolet-radiation sources. Preferably, the opposing side of the filter is the side where a filtered liquid exits the filter.

A further ultraviolet-radiation source could reduce the risk of allowing a contaminated liquid to flow back to the food processing machine. The liquid exits the filter and flows to the outlet, wherein said flow the further ultraviolet-radiation source is arranged inside to maximize efficiency. In a further preferred embodiment, it could be advantageous to arrange a plurality of further ultraviolet-radiation sources on the opposing side with varying intensities.

The further ultraviolet-radiation irradiates a further filtration surface, wherein said filtration surface is defined by the same length, width and height as the filtration surface, but on the opposing side of the filter.

According to a preferred embodiment of the present invention, the entering liquid is a marinade or saline solution, especially brine. These named liquids are mostly used in the food processing industry, wherein said liquids are mostly injected into or sprayed onto food products or food products are inserted into a liquid stream of said liquids. In a preferred embodiment, every liquid used for the treatment of food within the food processing industry can be filtrated and disinfected with the given apparatus. The brine is typically a watery solution with salt and/or other functional and/or taste enhancing substances in any given concentration.

According to another preferred embodiment of the present invention, the filter comprises a plurality of sections, wherein the number of openings and/or the diameter of the openings of the filter vary between the sections. The filter may have different sections, wherein within the sections the number of openings, the diameter or the cross-section of the openings can vary or be the same. Preferably, a section or all sections can have no openings, wherein this increases the time of exposure to ultra-violet radiation. This section is preferably placed at the beginning of the filter, as it is mostly desirable to increase exposure time to ultraviolet-radiation at the start of the filter as contamination concentration is the highest at the beginning of the filter in reference to the length of the filter and the progressing liquid along said filter. Further, the openings may vary in cross-sectional area. The cross-sections of the openings can be oblong (rectangular), circular, oval or triangular or any other form. The cross-sectional area and the number of the openings can be adjusted according to the viscosity of the liquid to be filtered. A viscous liquid may need more opening with a larger cross-sectional area, than a low viscous liquid.

Preferably, the number of openings increases with progressing length of filter. This allows for advantageously higher exposure times of ultraviolet-radiation.

Between every section, a small area without any openings can be arranged in order to increase stability of the filter. More openings can be comprised at the end of the filter, in a horizontal perspective, wherein less disinfection of the liquid might be necessary at this point. Depending on the fluid to be filtered and the particles within the fluid the diameter or the cross-section of the openings can preferably also be varied for the filter.

Alternatively preferably, the filter is designed with slot(s) each with a main extension direction which extends parallel to the length of the filter. This filter element leads to very good filtering results, without clogging. The filter element can be cleaned easily. Preferably, the filter width is the same as the width of the filtration unit, thereby no liquid can flow past the filter without being filtered.

In a further alternative embodiment, the filtration unit can comprise at least one board element without any openings, which can be arranged in parallel on the filter. The board element could thereby be placed between the liquid flow and the filter, wherein the liquid would flow over the board element and could be exposed to ultraviolet-radiation before being filtered. The board element can be the same length, width and form as the filter or only be a part of the length or width of the filter. A preferred embodiment could comprise a board element being arranged oppositely to the filter, wherein the board element could originate from the weir and end at an opposing wall of the filtration unit, wherein the filter could start beneath the board element at the opposing wall of the filtration unit and could be arranged to end beneath the weir. This would allow the liquid to be at first disinfected by ultraviolet-radiation and then the liquid would be filtered. The board element could be arranged in parallel to the filter and/or any ultraviolet-radiation sources.

In a preferred embodiment, wherein the width of the filtration unit is larger than the width of the filter, the filtration unit may comprise blockades to prevent the liquid to flow through any gaps between any sides of the filter and the filtration unit caused by the difference in widths of the filtration unit and the filter. Said blockades can be a wall arranged on the filter to prevent the liquid flowing from any side of the filter or any boards or objects blocking the liquid flow from the sides of the filter. These apparatuses can further be used to place any holding elements for the ultraviolet-radiation sources on.

Preferably, the filter is at least locally, preferably entirely, inclined relative to a vertical and/or horizontal plane. Due to this inclination, the liquid need not be pumped but flows by gravity along the filter. The angle of inclination may vary with the flow length of the liquid. Preferably, the angle of inclination relative to a horizontal plane decreases with increasing flow-length. The angle of inclination is preferably between 0 and 90° more preferably between 0 and 20°. The angle of inclination affects the flow speed of the liquid over the filter and in combination with the cross-sectional area of the openings of the filter and the number of the openings of the filter, influence the time of exposure to ultraviolet-radiation.

Preferably filter is at least locally curved. The radius of the curvature can vary within the filter design in a broad range preferably between 800 till 8000 mm and will more preferably be in a range from 1000 till 3000 mm. The unfiltered liquid flows along the filter by gravity and/or is pumped along the filter. The filtered liquid is forced through the filter element by gravity and/or by increased pressure, which, according to a preferred embodiment, can be controlled. The increased pressure can, for example be achieved by a higher liquid level on top of the filter. The pressure level need not be the same over the entire flow length of the filter, but may vary.

According to another preferred embodiment of the present invention, the filter comprises flow chicanes, wherein the flow chicanes are arranged in the surface of the filter at an angular range of 0°-90°, especially 45°-70°, to the direction of the liquid flow along the filter. The flow chicanes can be arranged everywhere on the filter and be in any form. The main result achieved by the flow chicanes is to reduce the flow speeds along the filter. Thus, creating higher exposure times to the ultraviolet-radiation and thereby allowing for better disinfection of the liquid. The flow chicanes can further cause turbulent flows within the liquid flow, which creates a homogenous liquid and enables better disinfection of the liquid as a whole. The flow chicanes can be placed in between the different sections of the filter.

According to another preferred embodiment of the present invention, the filtration unit comprises a collecting tank to collect the exiting liquid. The collecting tank can be placed between the outlet and the food processing machine, wherein the filtration unit could be connected to the collecting tank via a tube or pipe. Further, the collecting tank is preferably connected to the food processing machine via a tube or pipe. The collecting tank can collect the filtered and disinfected liquid, before allowing the liquid to re-enter the food processing machine.

Advantageously, before allowing the filtered and disinfected liquid to re-enter the food processing machine, the liquid may be tested for any microbes or unwanted impurities.

In another preferred embodiment, the filtration unit comprises a further collecting tank, wherein the collecting tank is located between the inlet and the food processing machine. Prior to entering the filtration unit, the liquid can be tested and depending on the contamination and the particle sizes comprised within, the intensity and the height of the ultraviolet-radiation sources and the filter might be chosen.

In a further preferred embodiment, the filtration unit comprises only one total collecting tank. The total collecting tank can function as the collecting tank and the further collecting tank together. The total collecting tank could be advantageous, when the filtration unit needs a minimum liquid level to function. Further, the exiting liquid could be filtered and disinfected another time, allowing no microbes to remain within the liquid. A pump could be used with any of the tanks in order to create pressure and allow for liquid flow out of the tanks. Preferably, the ultraviolet-radiation only irradiates the filter, when the pump within the tank is running. In a preferred embodiment, where the food processing machine is directly fluidly connected to the filtration unit, the ultraviolet-sources could also only be switched on, when the food processing machine is on. The ultraviolet-radiation sources could be linked to any machine, which is vital for the food processing, wherein said machine would indicate that a liquid ought to be disinfected and filtered.

According to another preferred embodiment of the present invention, the filtration unit comprises a weir and a regulatory valve to control the liquid flow over the weir. The weir enables the filtration unit to collect a given amount of liquid and to allow for a controlled flow onto the filter. When the weir is filled, the collected liquid overflows the weir and can flow onto the filter. In an alternative embodiment, the liquid flow can be controlled by a regulating pump. This feature can either be used in combination with the weir and a regulatory valve, with just either the weir or the regulatory valve or none of the two.

Further, when the weir fills up quickly and the flow rate onto the filter is too high, a regulatory valve can allow for a controlled flow rate. The height of the weir defines the amount of the entering liquid that can be collected within the reservoir. The regulatory valve might be adjusted manually or via an electric actuator. The electric actuator can be controlled by sensor data from a flow sensor or any other sensor allowing for the calculation of a flow rate.

Further advantageously, the regulatory valve can also be seen as a protective layer for the ultraviolet-radiation sources. If the sources are arranged closely to the liquid flow, the liquid flow cannot reach a certain height. Even further, the regulatory valve can function as a splash guard for the ultraviolet-radiation sources. These sources are negatively affected by a dried-up dirt layer on the source and thus, lose efficiency. Splashes or more on the source can cause refractions, when dried up on the source.

According to another preferred embodiment of the present invention, the disinfection means comprises an ozone inlet, wherein the inlet is configured to inject ozone in either gaseous form or dissolved in water into the filtration unit. An ozone disinfection can be used additionally to the ultraviolet-radiation. Ozone can either enter the filtration unit through a valve in gaseous form or be sprayed onto the liquid via nozzles, wherein the ozone is dissolved in water. For the use of ultraviolet-radiation in combination with ozone special safety precautions might be necessary, wherein in a preferred embodiment these safety precautions are comprised within the filtration unit.

According to a preferred embodiment of the present invention, the filtration unit comprises a cooling means between the food processing machine and the outlet. Higher temperatures set an ideal environment for undesired microbes to propagate. Especially, when the liquid is not reused directly after filtration and disinfection, the resting time in combination with the higher temperatures can allow for a fastened reproduction time of the microbes. Thereby, cooling the liquid allows for higher resting times of recycled and cooled liquids. Preferably, the cooling means could also be arranged within the total collecting tank, wherein the total collecting tank receives and/or collects the entering and exiting liquid. Thereby, the entering and the exiting liquid could be cooled.

Another preferred embodiment comprises a cooling means and a collecting tank, the cooling means is located between the outlet and the collecting tank. Preferably, a second cooling means is located between the inlet and the food processing machine. For highly contaminated liquids the cooling means before entering the filtration unit can advantageously stop any fast propagation of any microbes and advantageously prevents high amounts of microbes within the filtration unit. The cooling means preferably cools the liquid down to 2-4° C. and/or maintains the liquid at this temperature range. Preferably, the cooling means comprises a pump, which pumps the recycled liquid from a reservoir to the food processing machine.

According to a preferred embodiment of the present invention, the filtration unit comprises a protective layer located between the filter and the ultraviolet-radiation source, wherein the protective layer allows the ultraviolet-radiation to pass through. The protective layer can protect the source from any splashes or liquids. The risk of decreasing efficiency through dried up remains of any liquid on the ultraviolet-radiation sources is reduced drastically. The protective layer can either be made of a glass or plastic or any material suitable for the usage with food and that is transparent for ultraviolet-radiation.

Preferably, the protective layer is removable and adjustable in height. Depending on the height of the ultraviolet-radiation sources and the height of the liquid on the filter the protective layer might also be adjusted in height. Further, for cleaning purposes the protective layer is removable, as dried up liquid on the protective layer can cause refractions and reduce efficiency of disinfection.

The invention further relates to a method for processing a liquid via a filtration unit according to the present invention, wherein the liquid is filtered and simultaneously irradiated by ultraviolet-radiation. Preferably, in a first step a liquid enters the filtration unit through an inlet and in a second step the entering liquid flows over and through a filter, creating a surface of a mixture of to be filtered liquid and residue. The surface of the filter can simultaneously be irradiated by ultraviolet-radiation, for the purpose of disinfection. The liquid is forced through the filter via gravitational forces and pressure caused by the creation of pressure due to liquid on the filter. In a last step the liquid exits the filtration unit through an outlet preferably, wherein the bottom of the filtration unit can be slightly inclined, which allows for a liquid flow out through the outlet solely via gravitational forces. This method allows for highly efficient filtering and disinfection of any liquid, while simultaneously allowing for quick deconstruction and cleaning of said unit.

According to another preferred embodiment of the present method, the exiting liquid is collected within a tank located between the outlet and the food processing machine.

According to another preferred embodiment of the present method, in a first step a liquid exiting the food processing machine is collected within a collecting tank, wherein in a second step the liquid within the collecting tank flows to the filtration unit. The collecting tank can comprise a cooling or heating means, in order to cool or warm the liquid within the collecting tank.

According to another preferred embodiment of the present method, the exiting liquid is directed directly into the food processing machine.

According to another preferred embodiment of the present method, the exiting liquid is cooled directly after exiting the filtration unit.

Preferably, a mixture of a liquid and residue builds up on the filtration surface.

Regarding the method, the advantageous features and embodiments described in connection to the filtration unit according to the present invention can either alone or in combination be applied to, as an alternative or in addition to the advantageous embodiments of the method, to the embodiments of the method.

### BRIEF DESCRIPTION OF THE DRAWINGS

The invention is now explained according to the Figures. These explanations do not limit the scope of protection.

FIG. 1 shows the inventive filtration unit.

FIG. 2 shows a first embodiment of the filtration unit.

FIG. 3 shows a second embodiment of the filtration unit.

FIG. 4 shows a third embodiment of the filtration unit.

FIG. 5 shows a cooling means in combination with the inventive filtration unit.

FIGS. 6a, 6b show exemplary embodiments of a filter used within the filtration unit.

FIGS. 7a, 7b show exemplary embodiments of a filter used within the filtration unit.

FIGS. 8a, 8b show exemplary embodiments of a filter used within the filtration unit.

FIG. 9 shows a fourth embodiment of the filtration unit.

### DETAILED DESCRIPTION

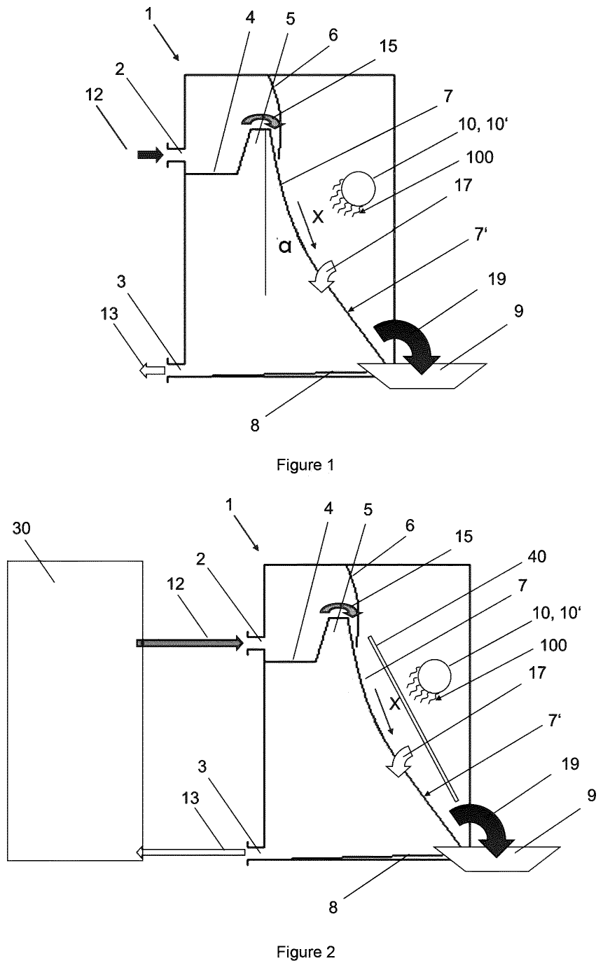

FIG. 1 shows the inventive filtration unit 1. The filtration unit 1 comprises an inlet 2, an outlet 3, a filter 7 and a disinfection means 10. Via the inlet 2 a liquid 12 that ought to be processed enters the filtration unit 1. The liquid 12 can be any liquid that has to be processed, coming from any food processing machine. Especially, the entering liquid 12 can be a marinade or a saline solution, wherein the saline solution is preferably brine. The entering liquid 12 can be collected within a reservoir 4, wherein the height of the weir 5 defines the amount of collected liquid. After the liquid reaches a maximum threshold within the reservoir 4, a liquid flow over the weir 15 flows onto the filter 7. The liquid can spread out over the full width of the filter 7 and progresses along the length of the filter x. The disinfection means 10 shown in FIG. 1 comprises an ultraviolet-radiation source 10′. This source irradiates a filtration surface 7′ with ultraviolet-radiation 100, while simultaneously being overflown by the liquid to be disinfected. Further, the filtration unit 1 comprises a sloped bottom 8, wherein the liquid flow through the filter 17 flows along the sloped bottom 8 via gravitational forces. The filtered and disinfected liquid exits the filtration unit 1 via the outlet 3. Even further, FIG. 1 shows a residue basin 9, which collects the residue 9 from the filter 7. Grease, fats and particles that are filtered out of the liquid, flow via gravity into the residue basin 9. The filter 7 can be inclined at an angle a relative to the vertical plane in order to exert higher forces on the liquid and residue via pressure and gravity. To control the flow rate on the filter 7 and to protect the disinfection means 10, the system can comprise a regulatory valve 6. The regulatory valve 6 is regulated by controlling the distance to the filter 7 and thereby, opening a smaller or larger area for the liquid to flow through. Preferably, for highly contaminated liquids the regulatory valve 6 is regulated to enable a smaller flow rate in order to disinfect the liquid accordingly.

FIG. 2 shows a first embodiment of the present invention. In addition to FIG. 1, FIG. 2 comprises a protective layer 40 and a food processing machine 30. A contaminated liquid exits the food processing machine 30 and can enter the filtration unit 1 via inlet 2. The disinfected and filtered liquid exits the filtration unit 1 through outlet 3 and can either directly flow back into the food processing machine 30 or be passed to a collecting tank or other processing machinery or the combination of any of the previously named. The protective layer 40 shown in FIG. 2 allows ultraviolet-radiation 100 to pass through but prevents any liquid splashing on the ultraviolet-radiation source 10′. The protective layer 40 can be made up of glass or plastics or material that fulfills the above-named features. As the ultraviolet-radiation source 10′ can be adjusted in height, the protective layer 40 can also be adjusted in height. When the ultraviolet-radiation source 10′ is placed further away from the filter, the protective layer can also be placed further away. The protective layer 40 is removable, as for a low flow rate it might be unnecessary to protect the ultraviolet-radiation source 10′ and accept any losses of efficiency via a dirty protective layer 40. The protective layer 40 might further be advantageous, when an embodiment of the present invention comprises an ozone inlet. The ozone inlet can inject ozone in gaseous form or spray the ozone dissolved in water onto the filter, wherein the nozzles of said inlet ought to be clean and be prevented from clogging up.

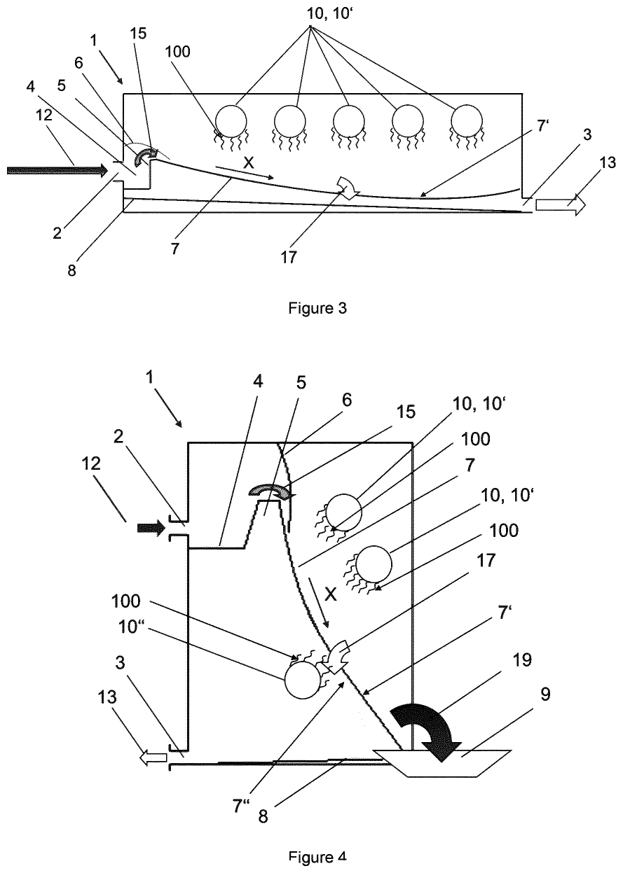

FIG. 3 shows a second embodiment of the present invention, wherein a plurality of ultraviolet-radiation sources 10′ are shown. Further, the embodiment shows the filter 7 inclined at a very high angle in relation to the vertical plane. This embodiment does not show a residue basin 9 for the collection of residue. The residue cannot flow through the filter 7 and thus, is held on the filter 7. It is a positive side effect of the present invention, that the residue is simultaneously disinfected to the liquid. This would allow for the residue to be stored longer before having to be disposed. Further, the residue basin 9 and any collecting buckets for the residue have a lower risk of having microbes inside after being exposed to the residue. Preferably, when the functioning of the filter 7 is limited by the residue on top of the filter 7, the filter 7 can be removed and the residue can be disposed in a basin. Further preferably, a cleaning machine in form of a vacuum cleaner or any pump, can be placed on the filter 7 and extract the residue from the surface of the filter 7′. As no microbes are left within the residue, the especially difficult to clean machinery used in combination with residue also faces lower risks of contamination.

The plurality of ultraviolet-radiation sources 10′ can be arranged along the length of the filter x. The height of the ultraviolet-radiation sources 10′ can be adjusted manually or by electric motors, wherein sensor data containing the flow rate of the liquid and the contamination of the liquid are brought into a processing unit, which can control the electric motors. Further, the intensity of the sources 10′ can be adjusted and varied between the plurality of sources 10′. In regions of high contamination, usually at the beginning of the filter (x=0), the intensity can be higher. With progressing length of the filter x, the intensity of the plurality of filters might decrease in a linear or non-linear relationship. It can be assumed that the contamination of the liquid also decreases with the increasing time of exposure to the ultraviolet-radiation 100 and thereby, allowing for a reduced intensity of ultraviolet-radiation 100 at the end of the filter 7. In a preferred embodiment the ultraviolet-radiation sources 10′ can be suspended from a top half of the filtration unit. The top half of the filtration unit 1 can be detachable and when removed, the cleaning of the filter 7 and the filtration unit 1 is easier.

The outlet 3 shown in FIG. 3 can be, unlike shown in the other embodiments, arranged on the opposite said of the inlet. The sloped bottom 8 is inclined towards the outlet 3, wherein this is caused by the relatively shallow embodiment. The outlet 3 can be placed on any side of the filtration unit 1, if the sloped bottom 8 can be sloped towards the outlet 3.

FIG. 4 shows another preferred embodiment comprising a further ultraviolet-radiation source 10″, wherein this source 10″ is located on the opposite side of the filter 7 to the ultraviolet-radiation sources 10′. The further ultraviolet-radiation source 10″ can be arranged in the liquid flow through the filter 17, wherein any microbes left within the liquid flow through the filter 17 can be disinfected by the further ultraviolet-radiation source 10′. In a further preferred embodiment, a plurality of further ultraviolet-radiation sources 10″ can be arranged within the liquid flow through the filter 17. The ultraviolet-radiation source 10′ irradiates a further surface of the filter 7″, wherein the further surface of the filter 7″ is on the opposite side of the filter to the surface of the filter 7′. The placement of the further ultraviolet-radiation source 10″ within the liquid flow through the filter 17 can lead to more cleaning steps of said sources 10″. Any dried-up liquid on the sources may lead to efficiency losses of the sources 10′ or 10″.

FIG. 5 shows an embodiment of the present invention in combination with a cooling means 20. Said cooling means 20 is placed between the outlet 3 and the food processing machine 30. Further, a collecting tank can be placed between the cooling means 20 and the food processing machine 30. As it may be advantageous to collect the exiting liquid 13, when it is cooled in order to stop the propagation of microbes within. The cooling means 20 can comprise a pump in order to pump the cooled liquid back into the food processing machine 30. Preferably, the cooling means 20 can cool the liquid down to 2-4° C. The collecting tank and the cooling means can each comprise a pump, wherein one pump is especially used for cooling purposes and one pump is especially used for circulation purposes.

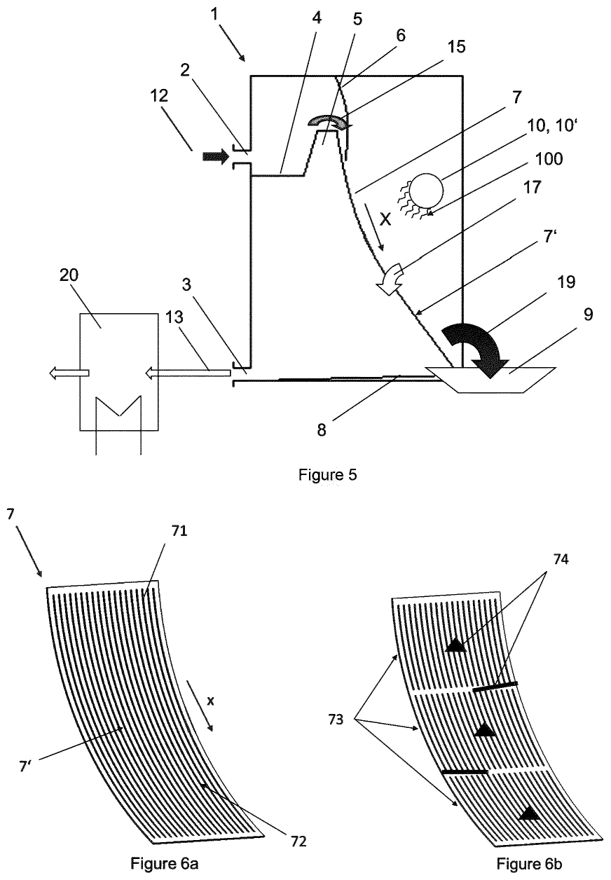

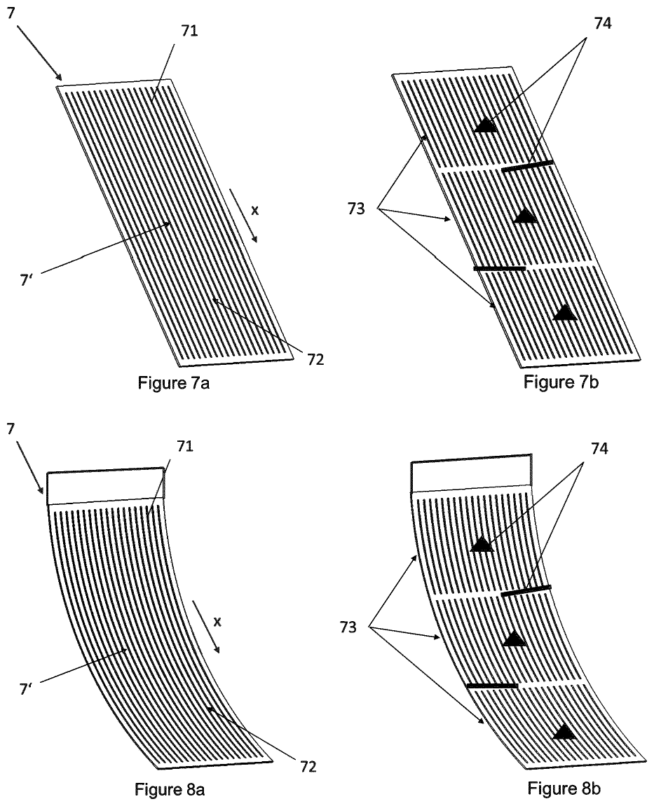

FIGS. 6a, 6b and FIGS. 7a, 7b show exemplary embodiments of filter 7 within the filtration unit 1. FIG. 6a shows an embodiment of the filter 7. In the present case, the filter 7 is at least locally curved and is proved at least locally inclined relative to a horizontal plane. The unfiltered liquid flows along the filter 7 as depicted by the arrow x. The area that is in contact with the liquid is the filter area 72. In this area at least one, preferably a multitude, here four, slots 71 are provided. The slots 71 preferably extend parallel to the flow-direction of the liquid. Each slot has a main extension direction, which is preferably parallel to the flow-direction X of the liquid. The slots are provided preferably equidistantly and more preferably have all the same width w and/or length. The width is preferably 0.4-3.0 mm. The length of the filter 7 is preferably 500-2000 mm. All slots cover preferably 10-60% of the filter area 72. In FIG. 6b the slots are interrupted due to strength and stiffness reasons. In another preferred embodiments the slots on the filter 7 can be openings with a circular cross-section or any different form. The area of the cross-section may vary in dependency of the contamination of the liquid. The contamination status of the liquid can be test before allowing the liquid to enter the filtration unit, wherein on basis of said results the intensity and height of the ultraviolet-radiation sources 10′, 10″ can be chosen and the filter 7 and the openings. FIG. 6b further shows different sections 73 on the filter, wherein every section can comprise a different form or quantity of openings. Along the length of the filter x the number of openings can increase, due to less needed exposure time of the liquid to the ultraviolet-radiation 100. Flow chicanes 74 on the filter 7 can increase the exposure time to the ultraviolet-radiation 100, by decreasing flow speeds of the liquid. The chicanes 74 are arranged at an angle to the liquid flow and the form of the objects functioning as chicanes 74 can vary.

FIG. 7a shows an embodiment of the filter 7 wherein the filter 7 is straight and not curved. The filter 7 can comprise out of multiple straight elements connected to each other wherein the relative angle between the multiple elements varies. In FIG. 7b the slots are interrupted and the filter comprises flow chicanes.

A not shown embodiment comprises a combination of a curved filter element(s) connected to straight filter element(s) in order to direct the flow-direction X of the liquid as desired.

In all shown embodiments the slots extending parallel to the flow-direction X of the liquid however slots directed with a slightly different angle preferably between 0 and 90 degrees compare to flow-direction X will also be disclosed by the invention.

FIGS. 8a and 8b show a further embodiment of the filter 7, wherein the openings 71 (slots) for filtration purposes only begin at a given length x along the filter. The filter shown in FIGS. 8a and 8b are both curved, but this feature can also be used with any form of a filter, wherein the openings 71 only start at a given length x along the filter. Advantageously, this feature allows for better disinfection of the desired liquid, as no openings 71 are located at the start of the filter, the liquid cannot flow through said openings and gains increased time of exposure to ultraviolet-radiation 100.

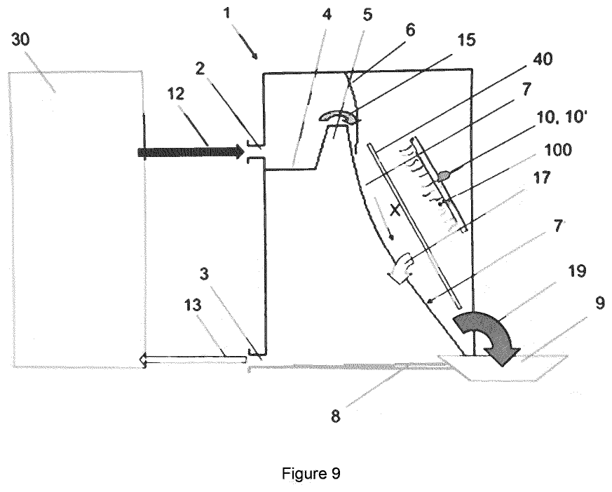

FIG. 9 shows another embodiment of the present invention. Reference is made to the disclosure in FIGS. 1-3. In the present case, the length extension of the ultraviolet-radiation sources, the disinfection means, extends in substantially parallel to the flow of the liquid and/or the length of the filtration surface. Preferably, the disinfection means comprises a plurality of ultraviolet-radiation sources (not depicted). The plurality of ultraviolet-radiation sources can radiate different ultraviolet-radiation intensities and/or different wave-length or the same. The plurality of ultraviolet-radiation sources can be arranged substantially in parallel to the flow of the liquid and/or the length of the filtration surface. Each source can be controlled individually in terms of amplitude and/or wave-length.

### REFERENCE SIGNS

1—Filtration Unit
2—inlet
3—outlet
4—reservoir
5—weir
6—regulatory valve
7—filter
7′—filtration surface exposed to ultraviolet-radiation
7″—further surface exposed to ultraviolet-radiation
8—sloped bottom
9—residue basin
10—disinfection means
10′—ultraviolet-radiation source
10″—further ultraviolet-radiation source
12—entering liquid
13—exiting liquid
15—flow of liquid over weir
17—liquid flow through filter
19—residue
20—cooling means
30—food processing machine
40—protective layer
71—opening
72—filter area
73—filter sections
74—flow chicanes
100—ultraviolet-radiation
X flow direction of the liquid, flow length, main extension direction
α angle of inclination, relative to a vertical plane

1. A filtration unit for processing a liquid, wherein the filtration unit comprises an inlet, an outlet, a filter, and a disinfection means, wherein the inlet and the outlet are each connected to a food processing machine, the disinfection means comprises an ultraviolet-radiation source, wherein the disinfection means is configured to irradiate ultraviolet-radiation onto a filtration surface, wherein the filtration surface has a length and a width that is overflown by the liquid during filtration, wherein the length of the filtration surface extends parallel to a liquid flow direction and the width extends perpendicular to the liquid flow direction, wherein the filter has openings and a number of the openings increase with progressing length of the filter.

2. The filtration unit according to claim 1, wherein the disinfection means comprises a plurality of ultraviolet-radiation.

3. The filtration unit according to claim 2, wherein the plurality of ultraviolet-radiation sources are arranged along the length of the filter.

4. The filtration unit according to claim 2, wherein the plurality of ultraviolet-radiation sources are configured to emit different and/or the same intensities and/or different and/or the same wavelengths of ultraviolet-radiation.

5. The filtration unit according to claim 2, wherein at least one further ultraviolet-radiation source is arranged on an opposing side of the filter to the ultraviolet-radiation source.

6. The filtration unit according to claim 5, wherein the at least one further ultraviolet-radiation source irradiates a further surface of the filter.

7. The filtration unit according to claim 1, wherein the liquid is a marinade, saline solution, or brine.

8. The filtration unit according to claim 1, wherein the filter comprises a plurality of sections, wherein the number of openings and/or a diameter of the openings of the filter vary between the sections.

9. The filtration unit according to claim 1, wherein the filter comprises flow chicanes, wherein the flow chicanes are arranged in the surface of the filter at an angular range of 0°-90° to the liquid flow direction along the filter.

10. The filtration unit according to claim 1, wherein the filtration unit comprises a collecting tank to collect exiting liquid.

11. The filtration unit according to claim 1, wherein the filtration unit comprises a weir and a regulatory valve to control liquid flow over the weir.

12. The filtration unit according to claim 1, wherein the disinfection means comprises an ozone inlet, wherein the ozone inlet is configured to inject ozone in either gaseous form or dissolved in water into the filtration unit.

13. The filtration unit according to claim 1, wherein the filtration unit comprises a cooling means between the food processing machine and the outlet.

14. The filtration unit according to claim 1, wherein the filtration unit comprises a protective layer located between the filter and the ultraviolet-radiation source, wherein the protective layer allows the ultraviolet-radiation to pass through.

15. A method for processing the liquid via the filtration unit according to claim 1, wherein the liquid is filtered and simultaneously irradiated by the ultraviolet-radiation.

16. A method for processing the liquid via the filtration unit according to claim 1, wherein in a first step, a liquid exiting the food processing machine is collected within a collecting tank, and in a second step, the liquid within the collecting tank flows to the filtration unit.

17. The method according to claim 15, wherein the exiting liquid is collected within a tank located between the outlet and the food processing machine.

18. The method according to claim 15, wherein the exiting liquid is directed directly into the food processing machine.

19. The method according to claim 15, wherein the exiting liquid is cooled directly after exiting the filtration unit.
